(19) United States
(12) Patent Application Publication
(10) Pub. No.: US 2014/0028484 A1
(43) Pub. Date: Jan. 30, 2014

(54) ELECTROMAGNETIC ANECHOIC CHAMBER

(71) Applicant: TEN-CHEN HO, Tu-Cheng (TW)

(72) Inventor: TEN-CHEN HO, Tu-Cheng (TW)

(73) Assignee: HON HAI PRECISION INDUSTRY CO., LTD., Tu-Cheng (TW)

(21) Appl. No.: 13/588,102

(22) Filed: Aug. 17, 2012

(30) Foreign Application Priority Data
Jul. 26, 2012 (CN) 2012102612215

(51) Int. Cl. H01Q 17/00

(52) U.S. Cl. 342/1

(57) ABSTRACT

An electromagnetic anechoic chamber for testing information technology equipments (ITE) includes an anechoic chamber, a test bench installed in the anechoic chamber, and two tables for supporting the ITE. The tables slide in the anechoic chamber in turn. The test bench includes a first supporting plate defining two substantially parallel slide grooves and a through hole between the slide grooves, and a lift apparatus installed to a bottom of the first supporting plate. Each table includes an uninterruptible power system (UPS) detachably installed to the table. The lift apparatus includes a second supporting plate slidably received in the through hole from top to bottom. Each table slides on the first supporting plate along the slide grooves, until a corresponding UPS is supported on the second supporting plate. The lift apparatus moves the second supporting plate down, so that, the UPS is received in the through hole.

### BACKGROUND

1. Technical Field

The present disclosure relates to quality testing of information technology equipment (ITE), and particularly to an electromagnetic anechoic chamber for testing the ITE.

2. Description of Related Art

Electromagnetic or radio frequency anechoic chambers are used in quality testing of ITE, such as personal computers and liquid crystal displays. In the test process, an ITE is assembled to the test bench. After the test of the ITE is accomplished, the electromagnetic anechoic chamber stops working. The ITE is disassembled from the test bench, and another ITE is assembled to the test bench for testing. However, assembling or disassembling the ITEs is time-consuming, and because the electromagnetic anechoic chamber is not operating during this time, the usage rate of the electromagnetic anechoic chamber is reduced.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a partial exploded isometric view of one embodiment of an electromagnetic anechoic chamber, wherein the electromagnetic anechoic chamber includes a test bench and two tables.

FIG. 2 is an exploded isometric view of the test bench of FIG. 1.

FIG. 3 is an exploded isometric view of one of the tables of FIG. 1.

FIG. 4 shows a using state of the electromagnetic anechoic chamber of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

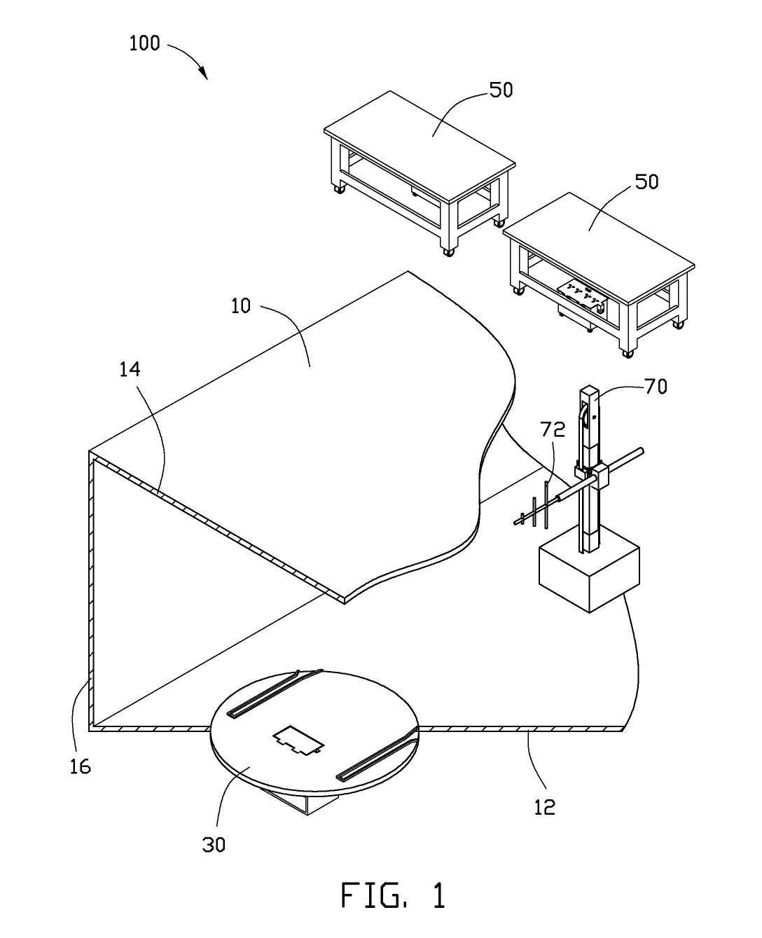

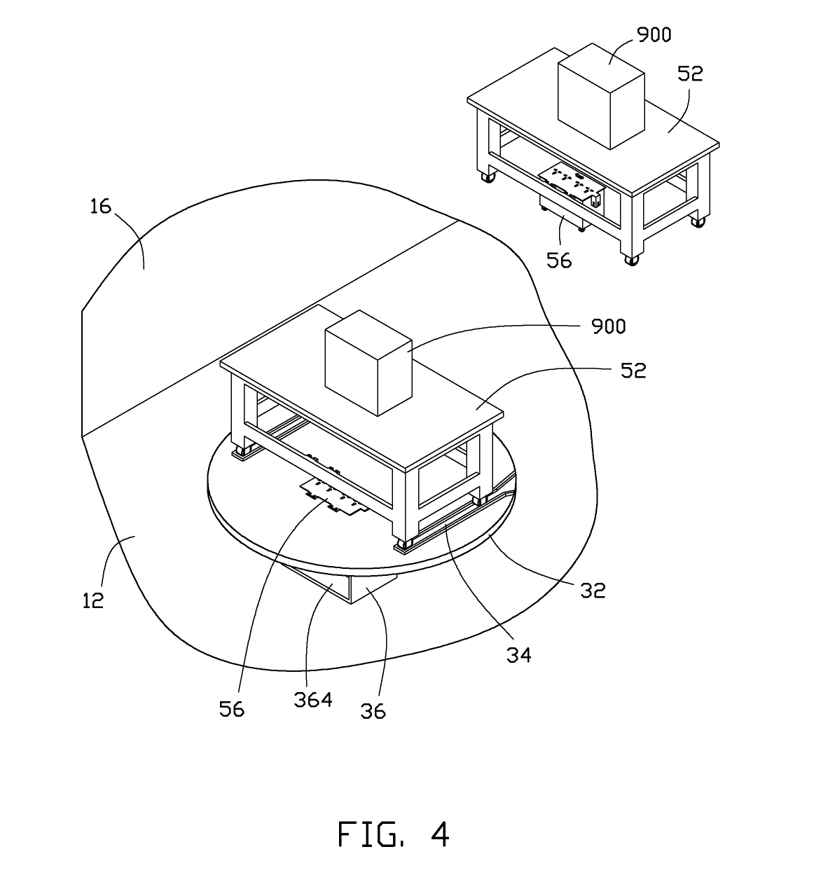

FIG. 1 shows one embodiment of an electromagnetic anechoic chamber 100 which can be used to measure intensity of electromagnetic radiation generated by items of information technology equipment (ITE) 900 (shown in FIG. 4), such as personal computers, liquid crystal displays, or mobile telephones. The electromagnetic anechoic chamber 100 includes an anechoic chamber 10, a test bench 30, two tables 50, and an antenna device 70. The antenna device 70 includes a test antenna 72 for receiving the electromagnetic radiation of the ITE 900.

The anechoic chamber 10 includes a bottom wall 12, a top wall 14 opposite to the bottom wall 12, and a sidewall 16 connected substantially perpendicularly between the bottom wall 12 and the top wall 14. Electromagnetic wave absorptive material is spread on inner surfaces of the top wall 14 and the sidewall 16. The test bench 30 is installed on a first end of the bottom wall 12, and the antenna device 70 is supported on a second end of the bottom wall 12 opposite to the test bench 30.

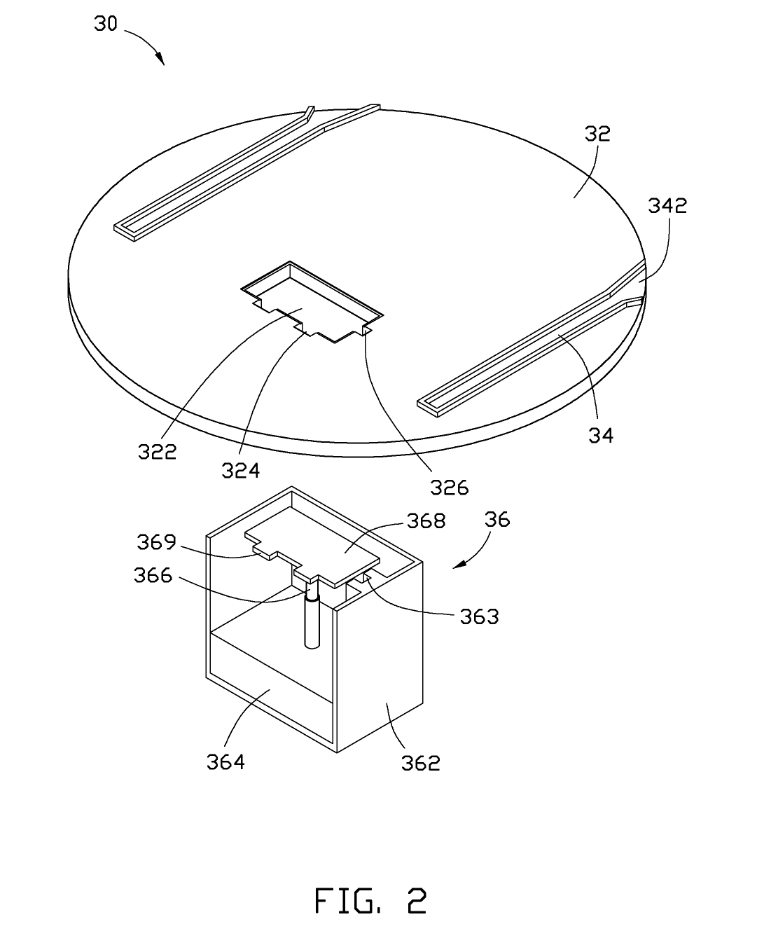

Referring to FIG. 2, the test bench 30 of the embodiment is shown. The test bench 30 includes a supporting plate 32 and a lift apparatus 36. The supporting plate 32 defines two substantially parallel slide grooves 34 and a rectangular through hole 322 between the slide grooves 34. Each slide groove 34 includes a wedge-shaped access 342 extending through a side of the supporting plate 32. A sidewall bounding the through hole 322 substantially perpendicular to a lengthwise direction of the slide grooves 34 and opposite to the wedge-shaped accesses 342 defines two first guiding slots 324, and an end surface of the through hole 322 adjacent to one of the slide grooves 34 defines a second guiding slot 326. The lift apparatus 36 includes a shell 362 mounted to a bottom surface of the supporting plate 32 opposite to the through hole 322, a cylinder 364 received in the shell 362, and a rectangular supporting plate 368. The cylinder 364 includes a telescopic rod 366 extending up, and the supporting plate 368 is supported on a distal end of the telescopic rod 366 opposite to the cylinder 364. Two tabs 369 protrude out from a side of the supporting plate 368. An inner surface of the shell 362 defines a power slot 363 extending along a direction substantially parallel to a lengthwise direction of the telescopic rod 366, and the power slot 363 is connected to a power system (not shown). The supporting plate 368 can be slidably received in the through hole 322 along a direction from top to bottom. The tabs 369 are slidably received in the first guide slots 324 along the direction from top to bottom, and the power slot 363 aligns with the second guiding slot 326.

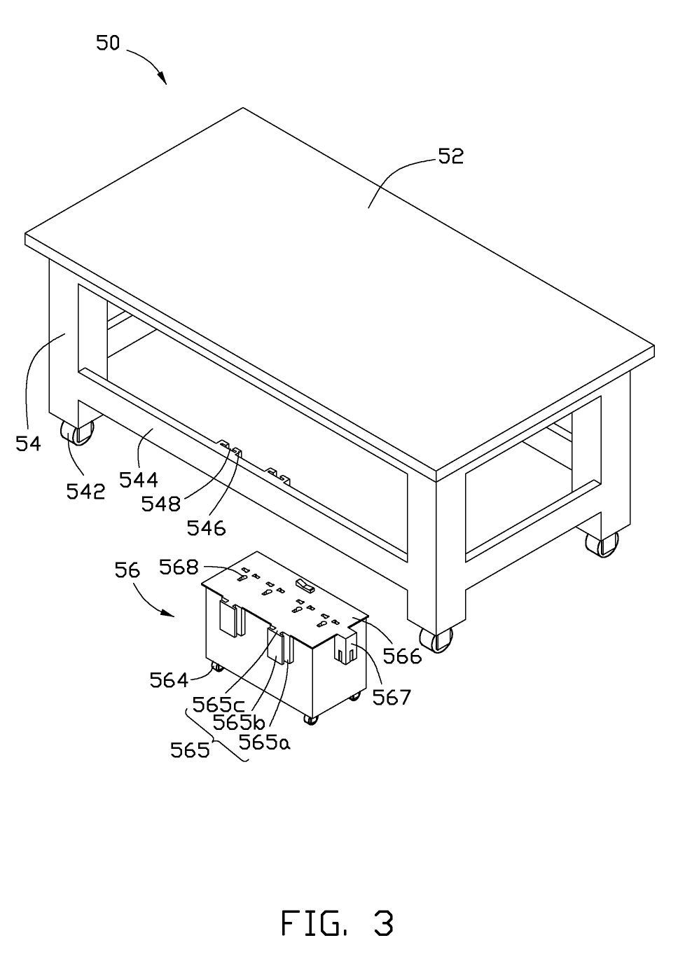

Referring to FIG. 3, each table 50 includes a rectangular top plate 52, four posts 54 extending down from four corners of the top plate 52, and an uninterruptible power system (UPS) 56. Four conveying pulleys 542 are respectively mounted on the undersides of the posts 54. A connecting pole 544 is connected between two of the posts 54. Two substantially parallel rectangular protrusions 546 protrude from an inner surface of the connecting pole 544. Each protrusion 546 defines a substantially T-shaped guiding slot 548 extending along a direction substantially perpendicular to the top plate 52. A plurality of conveying wheels 564 is mounted on an underside of the UPS 56. Two substantially parallel sliding members 565 protrude out from a side surface of the UPS 56. Each siding member 565 includes a mounting plate 565a mounted on the side surface of the UPS 56, a positioning plate 565b substantially parallel to the mounting plate 565a, and a connecting plate 565c connected between middles of the mounting plate 565a and the positioning plate 565b. The positioning plate 565b and the connecting plate 565c of each sliding member 565 can be slidably inserted into a corresponding guiding slot 548. A shielding plate 566 is installed on a top of the UPS 56, and defines a plurality of sockets 568. A plug 567 is formed on an end surface of the UPS 56, and can be inserted into the power slot 363 of the lift apparatus 36.

Referring to FIG. 4, in use, the sliding members 565 of the UPS 56 are inserted into the guiding slots 548 from an underside of the table 50. A first item of the ITE 900 is assembled on the top plate 52 of one of the tables 50. The power connector of the first item of the ITE 900 is connected to the socket 568 of the UPS 56, and the first item of the ITE 900 is powered on. The first one of the tables 50 is horizontally moved into the anechoic chamber 10. The conveying wheels 542 are received and rolled in the corresponding slide grooves 34 from the accesses 342. In addition, the conveying wheels 564 are moved until the UPS 56 is supported on the supporting plate 368 and the plug 567 aligns with the second guiding slot 326 and the power slot 363 of the lift apparatus 36. The cylinder 364 drives the telescopic rod 366 to withdraw moving the supporting plate 368 down. The UPS 56 of the first one of the tables 50 is received in the shell 362, and the plug 567 is inserted into the power slot 363. The first item of the ITE 900 and the UPS 56 are supplied with power through the power slot 363. The shielding plate 566 is covered on the supporting plate 32 for shielding the through hole 322. Electromagnetic radiations generated by the first item of the ITE 900 can be received by the antenna 72 of the antenna device 70. At the same time, a second item of the ITE 900 can be assembled on the other table 50, and the power connector of the second item of the ITE 900 is connected to the socket 568 of the USP 56. After the test of the ITE 900 is finished, the cylinder 364 drives the telescopic rod 366 to stretch to allow the supporting plate 368 to be restored. The plug 567 is disengaged from the power slot 363, and the sliding members 565 are inserted into the guiding slots 548. The first one of the tables 50 is moved out from the anechoic chamber 10, and the second one of the tables 50 is moved in the anechoic chamber 10 for testing. The first one of the tables 50 is exposed out of the anechoic chamber 10 for disassembling the first item of the ITE 900, and a third item of the ITE 900 can then be assembled in its place.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An electromagnetic anechoic chamber for testing information technology equipments (ITE), comprising:
an anechoic chamber;
a test bench installed in the anechoic chamber, and comprising a first supporting plate defining two substantially parallel slide grooves and a through hole between the slide grooves, and a lift apparatus installed to a bottom of the first supporting plate, wherein the lift apparatus comprises a second supporting plate slidably received in the through hole from top to bottom; and
two tables for supporting the ITE, wherein the tables slide in the anechoic chamber in turn, each table comprises an uninterruptible power system (UPS) detachably installed to the table, each table slides on the first supporting plate along the slide grooves until a corresponding UPS is supported on the second supporting plate, the lift apparatus moves the second supporting plate down, so that the UPS is received in the through hole.

2. The electromagnetic anechoic chamber of claim 1, wherein each table further comprises a rectangular top plate and four posts extending down from four corners of the top plate, and a conveying wheel is mounted on the underside of each post and is received and rolled in a corresponding slide groove.

3. The electromagnetic anechoic chamber of claim 2, wherein each table further comprises a connecting pole connected between two of the posts, and defines a guiding slot extending along a direction substantially perpendicular to the top plate, and the UPS further comprises a sliding member protrudes out from a side of the UPS and is inserted into the guiding slot.

4. The electromagnetic anechoic chamber of claim 3, wherein the guiding slot is substantially T-shaped, and the sliding member comprises a mounting plate mounted on the UPS, a positioning plate inserted into the guiding slot, and a connecting plate connected between the mounting plate and the positioning plate.

5. The electromagnetic anechoic chamber of claim 1, wherein the lift apparatus further comprises a shell mounted to the first supporting plate and a cylinder, the cylinder comprises a telescopic rod received in the shell, the second supporting plate is supported on a distal end of the telescopic rod, and the UPS is capable of being received in the shell.

6. The electromagnetic anechoic chamber of claim 5, wherein a power slot is defined in an inner surface, and a plug is formed on an outer surface of the UPS and is insertable into the power slot.

7. The electromagnetic anechoic chamber of claim 1, wherein the UPS further comprises a plurality of conveying wheels is mounted on an underside of each UPS.

8. The electromagnetic anechoic chamber of claim 1, wherein a shielding plate defines a plurality of sockets installed on a top of the UPS, and the shielding plate is covered on the first supporting plate for shielding the through hole.

9. The electromagnetic anechoic chamber of claim 1, wherein each slide groove comprises a substantially wedge-shaped access extending through a side of the first supporting plate.
